(19) United States
(12) Patent Application Publication
(10) Pub. No.: US 2014/0292301 A1
(43) Pub. Date: Oct. 2, 2014

(54) Low Power Bias Compensation Scheme Utilizing A Resistor Bias

(71) Applicant: BROADCOM CORPORATION, Irvine, CA (US)

(72) Inventors: Chang-Hyeon Lee, Irvine, CA (US); Lindel David Kabalican, Temecula, CA (US); Mark Jonathan Chambers, Huntington Beach, CA (US)

(73) Assignee: Broadcom Corporation, Irvine, CA (US)

(21) Appl. No.: 13/866,097

(22) Filed: Apr. 19, 2013

Related U.S. Application Data
(60) Provisional application No. 61/807,692, filed on Apr. 2, 2013.

(51) Int. Cl. H02M 3/158

(52) U.S. Cl. CPC H02M 3/158
USPC 323/299; 331/108 R

(57) ABSTRACT

Compensation circuitry includes a resistor and transistor coupled in series with a reference current source to generate a variable reference voltage that is provided, via a voltage regulator, to bias elements of a core circuit in order to establish an operating current in the core circuit. In one embodiment, the resistor and transistor of the compensation circuitry are of similar construction to the bias elements of the core circuit, such that fluctuations in the ratio of the reference current and the operating current of the core circuit are minimized over process, supply voltage and temperature variations. The voltage regulator may be a low dropout regulator. In various embodiments, the core circuit may comprise a resistor biased voltage controlled oscillator, a differential current mode logic (CML) input to single CMOS output circuit, or like circuitry that may be sensitive to phase noise or requires low power operation.

### CROSS REFERENCE TO RELATED PATENTS/PATENT APPLICATIONS

### Provisional Priority Claims

The present U.S. Utility patent application claims priority pursuant to 35 U.S.C. §119(e) to the following U.S. Provisional patent application which is hereby incorporated herein by reference in its entirety and made part of the present U.S. Utility patent application for all purposes:

1. U.S. Provisional Patent Application Ser. No. 61/807,692, entitled “LOW POWER BIAS COMPENSATION SCHEME UTILIZING A RESISTOR BIAS,” (Attorney Docket No. BP31812), filed Apr. 2, 2013, pending.

### BACKGROUND OF THE INVENTION

1. Technical Field of the Invention

The invention relates generally to bias compensation circuitry; and, more particularly, it relates to integrated compensation circuitry for reducing the effects of process, voltage and temperature variations.

2. Description of Related Art

In the design of electronic circuits, close attention must often be given to various sources of electrical noise. For example, in integrated circuit devices, flicker noise (or “1/f” noise) has the potential to negatively impact the performance of many types of circuits. Such noise is predominantly a low-frequency phenomenon, as it is often overshadowed by other types of noise at frequencies above a related corner frequency f_{c}. Metal Oxide Semiconductor (MOS) transistors, in particular, are known for producing deleterious 1/f noise with a power spectral density that is inversely proportional to frequency. In some circuits, such as certain types of oscillator circuits, low-frequency 1/f noise may be upconverted to higher frequencies, possibly inducing problematic oscillator phase noise.

For example, voltage controlled oscillator circuits (VCOs), such as high frequency VCOs used in communication applications, are typically designed to minimize phase noise within other design constraints such as power dissipation, output voltage swing, tuning range, etc. In general, phase noise can be viewed as random deviations or disturbances in the frequency of oscillation. Thus, when a VCO is utilized in certain types of phase-locked loops (PLLs), noise generated by the VCO may have a significant impact on the phase noise and time domain jitter at the output of the PLL. In order to reduce 1/f noise-induced phase noise in such circuits, resistor biased circuits are sometimes utilized in lieu of transistor-based current mirrors.

### BRIEF DESCRIPTION OF THE SEVERAL VIEWS OF THE DRAWINGS

FIG. 1 is a system diagram illustrating components of a system including circuitry according to one or more embodiments of the present disclosure.

FIG. 2 is a functional block diagram representation of an exemplary network employing compensation circuitry in accordance with an embodiment of the present disclosure.

FIG. 3 is a block diagram of a circuit including compensation circuitry for establishing a variable reference voltage in accordance with an embodiment of the present disclosure.

FIG. 4 illustrates a voltage controlled oscillator (VCO) utilizing compensation circuitry in accordance with an embodiment of the present disclosure.

FIG. 5 illustrates a VCO utilizing compensation circuitry in accordance with an alternate embodiment of the present disclosure.

FIG. 6 is a detailed circuit diagram of a differential current mode logic (CML) input to single-ended CMOS output circuit utilizing compensation circuitry in accordance with an embodiment of the present disclosure.

FIG. 7 is an operational flow diagram illustrating a method for reducing supply current variations in a core circuit in accordance with an embodiment of the present disclosure.

### DETAILED DESCRIPTION OF THE INVENTION

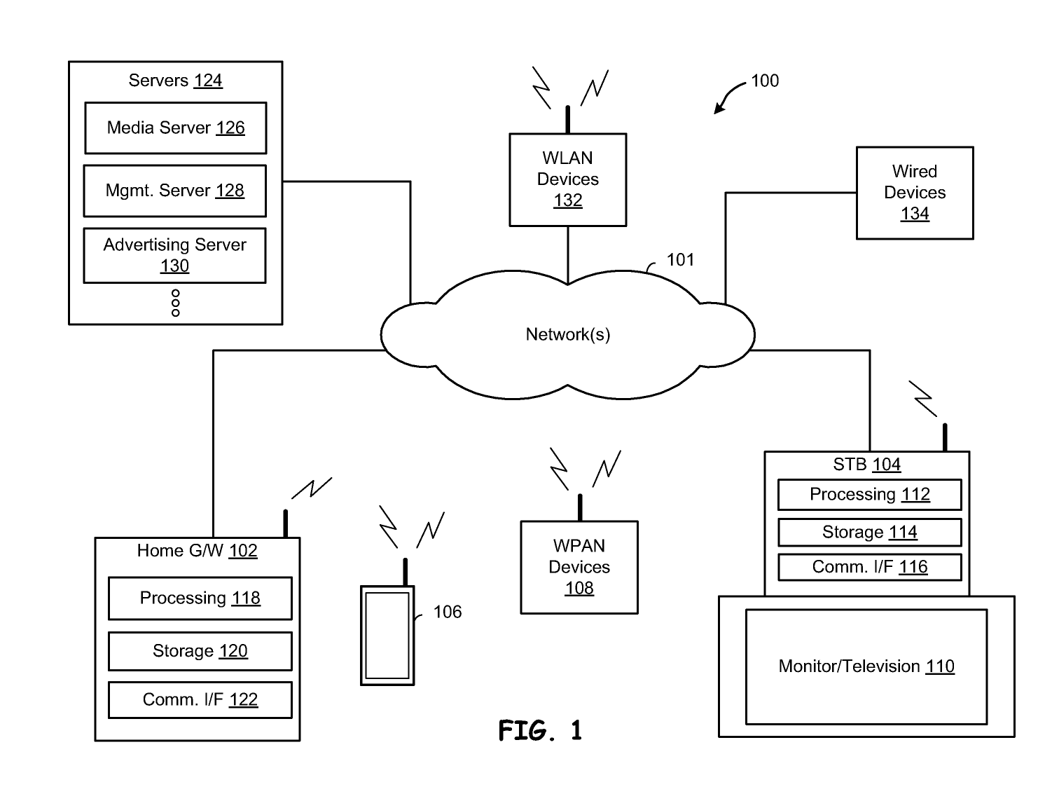

FIG. 1 is a system diagram illustrating components of a system 100 including circuitry according to one or more embodiments of the present disclosure. The illustrated system includes a home gateway (G/W) 102, a set top box (STB) 104, one or more communications network(s) 101, one or more smartphones and/or other mobile computing devices (e.g., tablet devices and laptop computers) 106, one or more wireless PAN (WPAN) devices 108, servers 124, one or more wireless LAN (WLAN) devices 132, and one or more wired devices 134.

In the illustrated system 100, each of the home G/W 102 and STB 104 includes processing 118/112, storage 120/114, and communication interface 122/116 resources. The STB 104 may service, for example, a coupled entertainment system, which may include a monitor/television 110 and sound system. Servers 124 may include, for example, a media server 126, a management server 128, an advertising server 132, etc., to support various local, distributed and/or cloud-based services and processing operations. The servers 124 may store, for example, media and advertising content, user data, profile information, etc.

The communication network(s) 101 may include one or more of the Internet, the World Wide Web (WWW), one or more Local Area Networks (LANs), one or more Wide Area Networks (WANs), one or more Personal Area Networks (PANs), one or more cellular communication networks, one or more Metropolitan Area Networks, and/or other types of networks. These network(s) 101 may service one or both of wired and/or wireless communications, and serve to support communications among various system components.

Each of the devices of FIG. 1 includes one or more integrated circuits. These integrated circuits enable various communication, processing, storage, and/or other device capabilities. Such integrated circuits are constructed using manufacturing processes that are designed to be consistent over time and circuit area, but typically are not. For a given integrated circuit design, variations in a manufacturing process may cause respective individual devices to exhibit differences in operational characteristics such as power consumption. Likewise, variations in integrated circuit supply voltages and operating temperatures may have a significant impact on device performance. Such variations in manufacturing process, supply voltage and temperature are often collectively referred to as “PVT” variations.

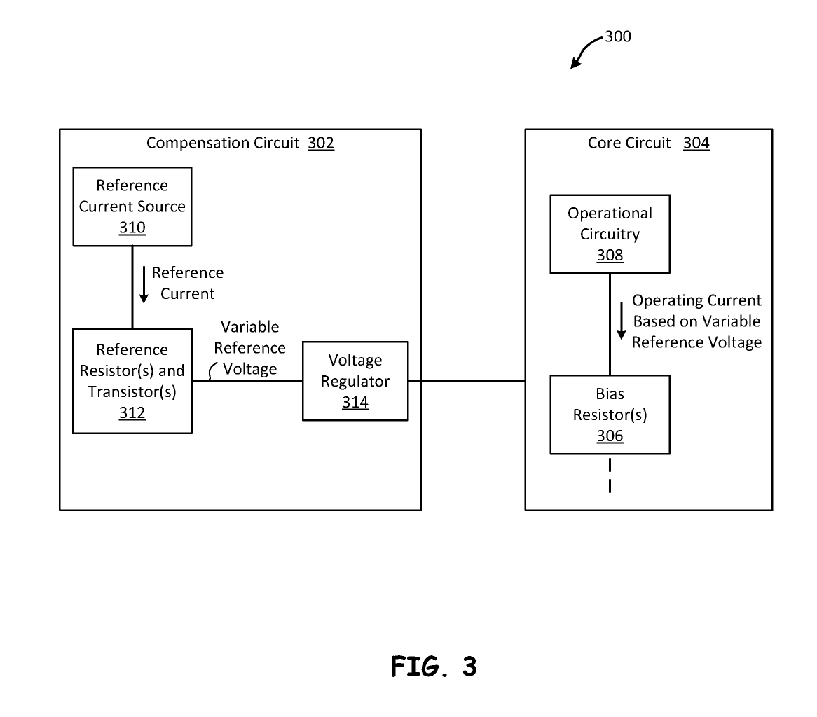

In order to overcome PVT variations, one or more of the integrated circuits utilized in the illustrated devices includes compensation circuitry constructed according to one or more embodiments of the present disclosure. This compensation circuitry (described in more detail with reference to FIGS. 3-6) mitigates the effects of PVT variations on certain types of integrated circuitry, thereby enabling more consistent and/or power efficient operation.

In addition, while certain embodiments of the disclosure presented herein are described for use in communication applications, various aspects and principles, and their equivalents, can also be extended generally to other applications. In some instances, structures and components described herein are illustrated in block diagram form in order to avoid obscuring the concepts of the subject technology.

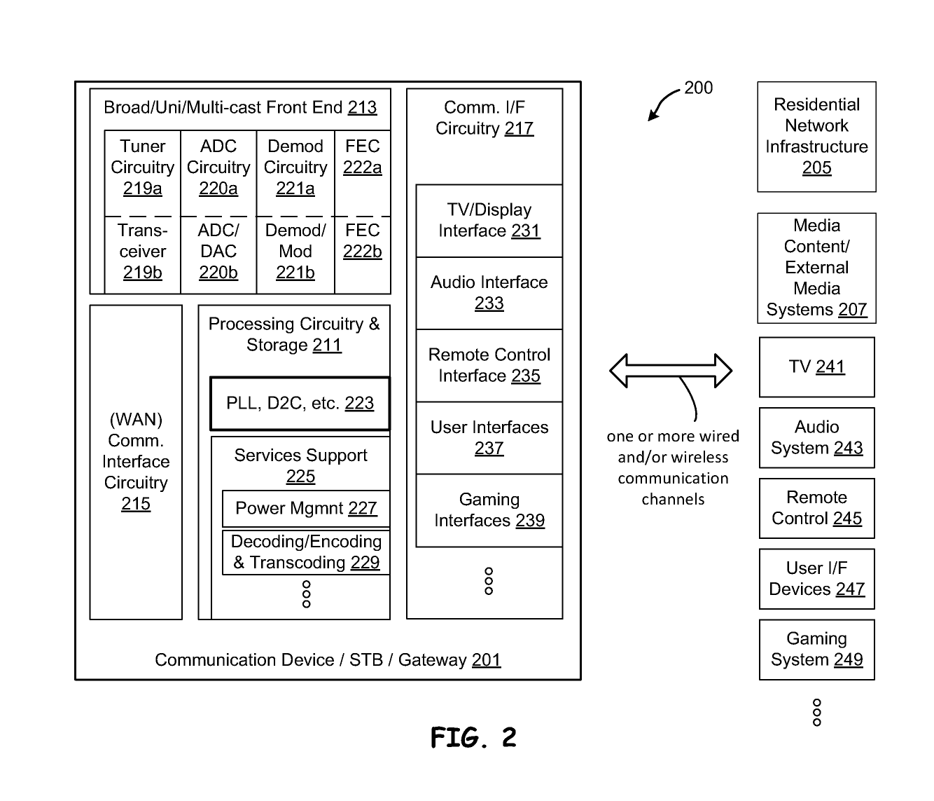

FIG. 2 is a functional block diagram representation of an exemplary network 200 employing compensation circuitry in accordance with an embodiment of the present disclosure. In this embodiment, a communication device, STB or gateway 201 (hereinafter “device 201”) provides a number of functions, including conversion of signals from external sources into content that can be consumed by network devices. The device 201 may further operate as a gateway that supports unidirectional or bidirectional communications and bridging between network devices.

The device 201 of the illustrated embodiment interacts with a residential network infrastructure 205 and external media systems 207 via one or more wired and wireless networks/links. The wired and wireless networks/links may utilize one or more of various transmission media—such as coaxial cable, shielded twisted pair cable, fiber-optic cable, power line wires, and wireless media (radio frequencies, microwave, satellite, infrared, etc.)—and operate in accordance with a variety of communication and networking protocols (TCP/IP, UPnP, IPv6, etc.). In addition, the wired and wireless networks/links may comprise a multi-hop network utilizing a spanning tree protocol, direct wireless connections, peer-to-peer links, etc.

The external media systems 207 may comprise, for example, one or more of cable, satellite and/or terrestrial televisions systems. Various headend equipment and services can be utilized by these systems, such as a cable headend that receives television signals for further processing and distribution, and may offer various other services such as internet connectivity and VoIP services.

The device 201 of the illustrated embodiment includes a broadcast/unicast/multicast front end 213 that operates to receive uncompressed or compressed digital video, digital audio and other data signals, from either the external media systems 207 or residential network infrastructure 205, for further processing and distribution. The front end 213 comprises tuner circuitry 219a operable to isolate particular channels. Signals from the tuner circuitry 219a are then provided to analog-to-digital (ADC) circuitry 220a and demodulation circuitry 221a for conversion into binary format/stream. Once in binary format, forward error correction (FEC) circuitry 222a checks the integrity of the received binary stream. Audio, video, and data extracted from the binary stream may then be decoded (e.g., by services support 225) into formats suitable for consumption by downstream devices. It is noted that demodulation circuitry 221a may support one or more modulation techniques, such as Quadrature Phase Shift Keying (QPSK), Quadrature Amplitude Modulation (QAM), Coded Orthogonal Frequency-Division Multiplexing (COFDM), etc.

The front end 213 may be integrated into one or more semiconductor devices that may further support, for example, interactive digital television, networked DVR functionality, IP video over DOCSIS applications, and 3D graphics support. In addition, multiple tuner circuitry 219a (including in-band and out of band tuners), ADC circuitry 220a and demodulation circuitry 221a may be provided for different modulation schemes and television standards (such as PAL, NTSC, ATSC, SECAM, DVB-C, DVB-T(2), DVB-H, ISDB, T-DMB, Open Cable).

In one alternative embodiment of the disclosure, functionality of the device 201 is performed by a smartphone or mobile computing device (e.g., a tablet device or laptop computer). In this embodiment, the “front end” 213 comprises one or more wireless interfaces (including PHY and baseband functions), such as a cellular (3G, 4G, IMT-Advanced, etc.) or wide area network (HetNet, Wi-Fi, WiMax, etc.) interface. The interface may support one or more modulation and multiplexing techniques, such as OFDM, OFDMA, SC-FDMA, QPSK, QAM, 64QAM, CSMA, MIMO, etc. In the illustrated embodiment, the wireless interface comprises a transceiver 219b, analog-to digital (ADC) and digital-to-analog (DAC) circuitry, demodulation and modulation circuitry 221b and FEC (such as turbo codes or LDPC codes) circuitry 222b. Encoding, decoding and transcoding 225 functions may be provided by processing circuitry and storage 211.

The device 201 also includes (wide area network) interface circuitry 215 for communicating with residential network infrastructure 205 and/or external media system 207. Through the communication interface circuitry 215, the device 201 may communicate directly with upstream resources, or offer (bidirectional) bridged communications between such resources and devices (e.g., devices 241-149) coupled to the device 201.

In the embodiment of FIG. 2, device 201 interacts with a variety of devices 241-249 over one or more wired and/or wireless communication channels via communication interface circuitry 217. For example, a television or display interface module 231 communicates with a (digital) television 241 or other media display device to relay television programming and enable available interactive services. In certain embodiments, the television or display interface module 231 might include a remote user interface (RUI) server. Similarly, an audio interface 233 provides audio programming or audio library access to an audio system 243.

The communication interface circuitry 217 further comprises a remote control interface 235 for receiving control signals from a remote control 245. In addition to traditional remote control operations, the remote control 245 may further offer voice and/or gesture control signals that are relayed or mapped to relevant consumer devices. User interfaces 237 are also provided for communications with one or more user interface devices 247. Gaming interfaces 239 function to provide interactive communications with a gaming system 249. Such communications may involve, for example, online, multiplayer gaming between members of a social network and/or external players in a gaming platform.

The device 201 of the illustrated embodiment includes processing circuitry and storage capabilities 211 (components of which may be comprised of hardware, software, or combinations thereof). For example, the device 201 may include PLLs, differential CML input to single-ended CMOS output (D2C) circuits, and like circuitry 223 that utilize compensation circuitry such as that described more fully in conjunction with FIGS. 3-6 to mitigate the effects of PVT variations. The device 201 further includes services support 225, which may include various functions such as power management functions 227 and decoding/encoding/transcoding functionality 229. It is noted that the processing circuitry and storage capabilities 211 may be made available in whole or part as a network resource.

Briefly, a PLL such as may be included in circuitry 223 and/or other part of device 201 can be viewed as a closed-loop feedback control system that generates a signal in relation to the frequency and phase of a reference signal. In their most basic form, PLL mechanisms may be implemented using a phase/frequency detector (PFD), a charge pump, a voltage controlled oscillator (VCO), and a feedback path. The PFD produces an error signal by comparing a frequency and a phase of the VCO to a frequency and a phase of the reference signal. The charge pump generates a reference or tuning voltage to be applied to the VCO based on the error signal. The PLL responds to the tuning voltage by automatically raising or lowering an output frequency of the VCO until the frequency and a phase of the output frequency of the VCO is matched with the frequency and the phase of the reference signal. In some implementations, the PLL may also include an integer or fractional frequency divider in a feedback configuration between the VCO and the PFD.

Embedded applications such as transceiver circuitry/frequency synthesizers in an integrated circuit may require a various reference clocks generated by a PLL using a master reference clock. Such applications may include, for example, frequency synthesizers for digitally-tuned radio receivers and transmitters, the demodulation of frequency modulated (FM) and amplitude modulated (AM) signals, the recovery of clock timing information from a data stream, clock multipliers for use by processing circuitry, dual-tone multi-frequency (DMTF) and like decoders, other clock-and-data-recovery (CDR) circuits, etc.

Although the compensation circuitry of the disclosed embodiments is generally configured for use in PLL, D2C and like circuitry, it is noted that certain novel features and concepts are likewise applicable to other circuits, including other types of circuits having strict phase noise performance requirements and/or circuits employing a resistor biasing scheme. For example, compensation circuitry in accordance with the invention is generally applicable for use in low power, resistor biased circuits that may otherwise demonstrate relatively large fluctuations in supply currents due to PVT variations.

FIG. 3 is a block diagram of a circuit 300 including compensation circuitry 302 for establishing a variable reference voltage in accordance with an embodiment of the present disclosure. The variable reference voltage is utilized by a core circuit 304 to establish an operating current(s) through one or more bias resistors 306 and operational circuitry 308. The core circuit 304 may comprise a relatively low phase noise circuit such as VCO utilized in a PLL, a D2C circuit, etc.

The compensation circuit 302 of the illustrated embodiment comprises a reference current source 310 that provides a reference current to reference resistor(s) and transistor(s) 312. For example, a reference resistor and transistor 312 may be coupled in series between the reference current source 310 and ground, such that a voltage drop occurs across these elements. This voltage drop is shown as a variable reference voltage that is provided to an input of voltage regulator 314 and reflected at a corresponding output that is provided to the core circuit 304.

As will be appreciated, the value of the variable reference voltage provided to the voltage regulator 314 may vary as a result of the effects of PVT variations on the reference resistor(s) and transistor(s) 312. By utilizing this variable reference voltage to establish an operating current in the core circuit 304, the effects of PVT variations on bias resistor(s) 306 (as well as transistors coupled to the bias resistor(s)) are reduced, resulting in less variation in the operating current and reduced power dissipation in the core circuit 304 as compared to resistor-based biasing schemes utilizing a relatively stable reference voltage.

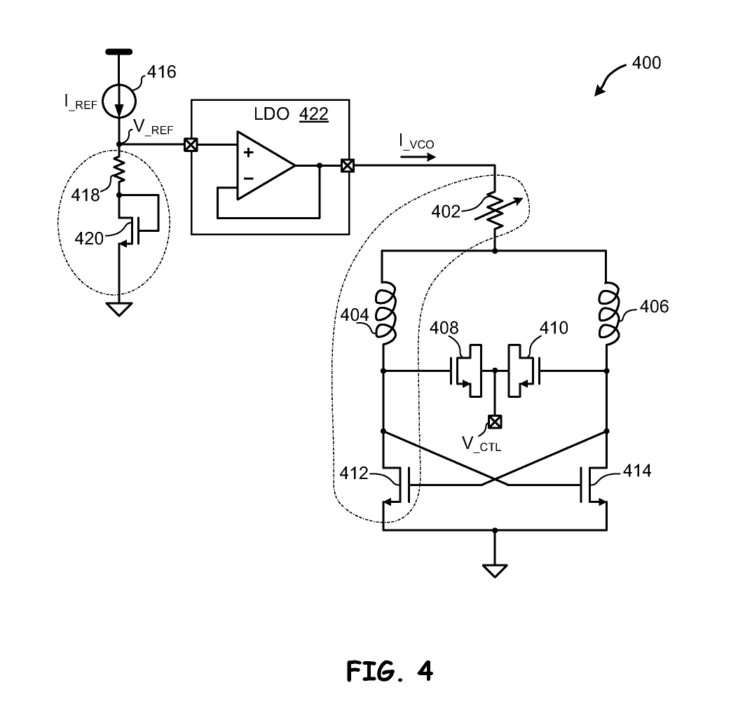

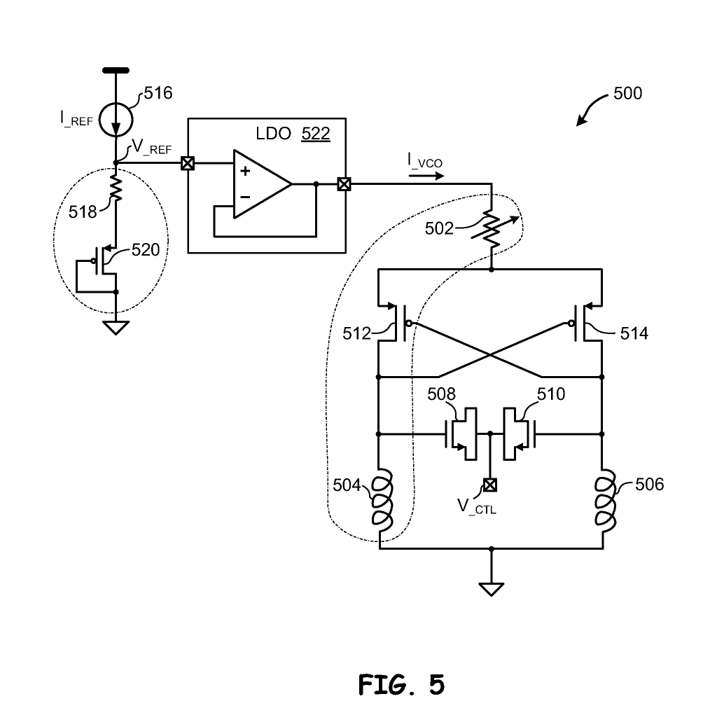

FIG. 4 illustrates a VCO 400 utilizing compensation circuitry in accordance with an embodiment of the present disclosure. The VCO 400 may be used, by way of example and without limitation, as part of a PLL. The VCO 400 of this embodiment is implemented utilizing n-channel field effect transistors (NFETs) manufactured in a complementary metal oxide semiconductor (CMOS) process. A p-channel field effect transistor (PFET) VCO circuit 500 is illustrated in FIG. 5.

In general, a VCO may be viewed as a positive feedback amplifier that has a tuned resonator in the feedback loop, and may be implemented as a LC VCO (where L represents the inductance and C the capacitance of the VCO), a crystal oscillator, a ring oscillator, etc. LC VCOs are one of the most common type of oscillators used in integrated communication circuits, and can be designed for both fixed frequency and variable frequency operation (e.g., through the use of a varactor). In addition to bias circuitry, an LC VCO typically consists of two main stages: a gain stage and an LC “tank” circuit that holds oscillating energy at the oscillation frequency.

Referring more specifically to FIG. 4, an NFET cross-coupled, resistor biased LC VCO topology is shown. In this embodiment, the core circuitry of the VCO 400 includes: a bias resistor/digital potentiometer 402 (“bias resistor 402”); a tank circuit comprised of inductors 404 and 406 (e.g., integrated spiral inductors) NFETs 408 and 410 acting as capacitive elements (e.g., accumulation-mode MOS varactors having a value determined by the bulk-to-gate voltage); and a gain stage formed of cross-coupled NFETs 412 and 414. The value of bias resistor 402 (which may be a digital potentiometer or variable, programmable resistor) is set such that the loop gain of the VCO 400 is sufficient to maintain oscillation over PVT variations, and may be programmed (for example) during the manufacture of the VCO 400 based in part on device characterization information. In general, the oscillation frequency of the VCO 400 is determined by the value of the MOS varactors 408 and 410, which in this embodiment is established by a control voltage VCTL applied to the bulk connection. The value of the control voltage VCTL may be determined, for example, based on error signals produced by a phase/frequency detector (PFD) of a PLL.

In the illustrated embodiment, and for a given value of bias resistor 402, the VCO operating current I_{—VCO} is established using compensation circuitry that includes a reference circuit comprised of a current source I_{—REF} 416 (e.g., a bandgap reference current source circuit), a reference resistor 418, and a NFET 420 coupled in series between a supply voltage and ground. In this embodiment, the gate and drain of the NFET 420 are both coupled to one side of the reference resistor 418 while the current source is coupled to the other side. The voltage drop across the reference resistor 418 and NFET 420 establishes a variable (over PVT) reference voltage V_{—REF} that is provided to an input of a voltage regulator such as a low-dropout (LDO) regulator 422. As noted, the corresponding (variable) output of the LDO regulator 422 is utilized to generate the VCO operating current I_{—VCO}.

As is known, an LDO regulator such as LDO regulator 422 generally varies its internal resistance (e.g., using an error amplifier) in accordance with a load to provide a well specified and fairly steady output voltage, and operates with a very small input-output differential voltage, or “dropout” voltage, such that the output voltage generally tracks the input voltage. The low dropout voltage (which may be less than 100 mv in some LDO regulators) provides the advantages of a lower minimum operating voltage and higher efficiency operation, such as may be required in mobile and battery-powered applications. The illustrated LDO regulator 422 may be part of the same integrated circuit device as the other illustrated circuitry. In alternate embodiments, the LDO regulator 422 may be a discrete component.

It is noted that the value of the variable reference voltage V_{—REF} provided to the input of the LDO regulator 422 may vary as a result of the effects of PVT variations on the reference resistor 418 and NFET 420. In the illustrated embodiment (and as generally indicated by the dashed lines), the bias resistor 402 may be manufactured of a common material and on the same substrate as reference resistor 418. Likewise, NFETs 412, 414 and 420 of this exemplary embodiment are of the same type and general construction. Thus, the effects of PVT variations on the compensation circuit and VCO core generally track each other and are mitigated by the corresponding variances in the variable reference voltage V_{—REF}. In particular, and as explained more fully below, the compensation circuitry functions to minimize variations in the respective current densities of I_{—REF} and I_{—VCO}.

In operation, the reference voltage V_{—REF} is generated by the product of R_{—418}*I_{—REF}+Vgs(NFET 420), which is effectively copied over to the output of the LDO regulator 422. The value of the VCO operating current I_{—VCO} is generally determined by the ratio of the reference resistor 418 and NFET 420 of the reference circuit to the bias resistor 402 and NFETs 412 and 414 of the VCO core circuitry. It would be reasonable to expect a current variation of 20% or less over typical PVT variations. By comparison, use of a relatively stable voltage reference (VSTBL, not illustrated) to bias the VCO core circuitry might result in much stronger PVT-related current variations, as represented by VSTBL−Vgs(NFET 412, 414)/R_{—402}.

FIG. 5 illustrates a VCO 500 utilizing compensation circuitry in accordance with an alternate embodiment of the present disclosure. In this embodiment, a PFET cross-coupled, resistor biased LC VCO topology is shown. The core circuitry of the VCO 500 includes: a bias resistor/digital potentiometer 502 (“bias resistor 502”); a tank circuit comprised of inductors 504 and 506 (e.g., integrated spiral inductors) and diode connected NFETs 508 and 510 acting as capacitive elements (e.g., accumulation-mode MOS varactors having a value determined by the bulk-to-gate voltage); and a gain stage formed of cross-coupled PFETs 512 and 514. The VCO 500 operates generally as described above in conjunction with FIG. 4.

In the illustrated embodiment, and for a given value of bias resistor 502, the VCO operating current I_{—VCO}, is established via a voltage generated by compensation circuitry that includes a reference circuit comprised of a current source I_{—REF} 516 (e.g., a bandgap reference current source circuit), a reference resistor 518, and a PFET 520 coupled in series between a supply voltage and ground. In this embodiment, the gate and drain of the PFET 520 are both coupled to ground, while its source is coupled to one side of the reference resistor 518. The current source is coupled to the other side of the reference resistor 518. The voltage drop across the reference resistor 518 and PFET 520 (R_{—518}*I_{—REF}+Vgs(PFET 520)) establishes a variable (over PVT) reference voltage V_{—REF} that is provided to an input of a LDO regulator 522. The output of the LDO regulator 522 is utilized as described above to generate the VCO operating current I_{—VCO}, which is generally determined by the ratio of the reference resistor 518 and PFET 520 of the reference circuit to the bias resistor 502 and PFETs 512 and 514 of the VCO core circuitry.

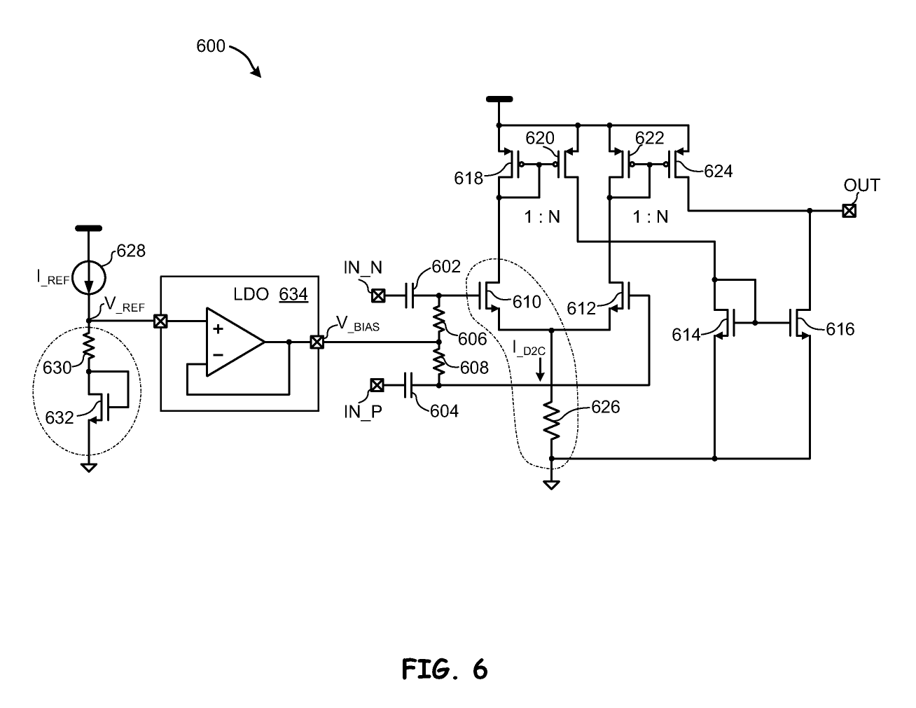

FIG. 6 is a detailed circuit diagram of a differential CML input to single-ended CMOS output (D2C) circuit 600 utilizing compensation circuitry in accordance with another embodiment of the present disclosure. Core circuitry of the illustrated D2C circuit 600 includes input capacitors 602 and 604 and resistors 606 and 608, NFETs 610-616, PFETs 618-624 and a bias resistor 626. In the illustrated embodiment, the D2C circuit operating current I_{—D2C} is established using compensation circuitry that includes a reference circuit comprised of a current source I_{—REF} 628 (e.g., a bandgap reference current source circuit), a reference resistor 630, and a NFET 632 coupled in series between a supply voltage and ground. In this embodiment, the gate and drain of the NFET 632 are both coupled to one side of the reference resistor 630 while the current source is coupled to the other side.

The voltage drop across the reference resistor 630 and NFET 632 establishes a variable (over PVT) reference voltage V_{—REF} that is provided to an input of a voltage regulator such as a low-dropout (LDO) regulator 634. In particular, the reference voltage can be generally represented by the product of R_{—630}*I_{—REF}+Vgs(NFET 632). The corresponding (variable) output of the LDO regulator is utilized to generate the D2C circuit operating current I_{—D2C}, the value of which is generally determined by the ratio of the reference resistor 630 and NFET 632 of the reference circuit to the bias resistor 626 and differential input stage NFETs 610 and 612 of the D2C core circuitry.

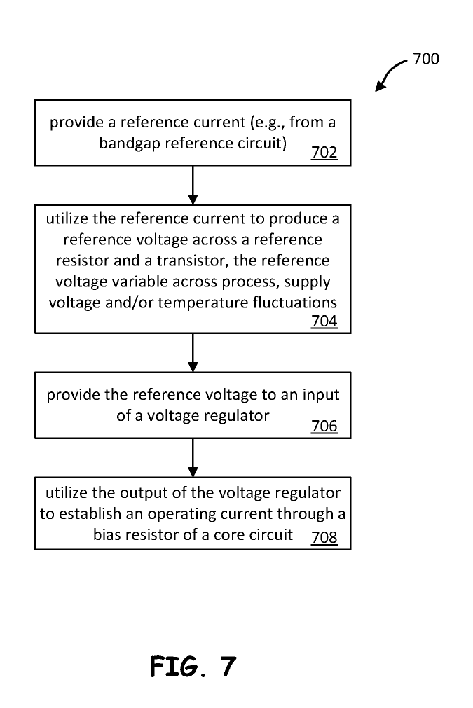

FIG. 7 is an operational flow diagram illustrating a method 700 for reducing supply current variations in a core circuit in accordance with an embodiment of the present disclosure. In step 702 of the illustrated method, a reference current is provided for use in compensation circuitry. The reference current may be provided, for example, by a bandgap reference or like circuit that provides a current having a relatively stable value or current density. Next, in step 704, the reference current is utilized to produce a reference voltage across a reference resistor and transistor. As described above, the value of this reference voltage may vary due to the effects of process, supply voltage and/or temperature fluctuations on (at least) the operational parameters of the reference resistor and transistor.

In step 706, the reference voltage is provided to an input of a voltage regulator. The resulting voltage at the output of the regulator is then utilized (step 708) to establish an operating current through a bias resistor of a core circuit. In certain embodiments, the reference resistor and the bias resistor are manufactured of a common material on a single substrate such that the resistors exhibit similar electrical properties under PVT variations. In addition, a transistor may be coupled in series with the reference resistor to further compensate for PVT variations experienced by one or more transistors coupled to a bias resistor.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. A circuit comprising:
a reference circuit including a current source, a reference resistor, and a transistor coupled in series between a supply voltage and ground, wherein the reference circuit produces a variable reference voltage;
a voltage regulator having an input and an output, the input coupled to the reference circuit to receive the variable reference voltage; and
a core circuit including a bias resistor coupled to operational circuitry, the core circuit coupled to the output of the voltage regulator such that an operating current is established through the bias resistor based, at least in part, on the variable reference voltage.

2. The circuit of claim 1 further comprises:
the reference resistor and the bias resistor being formed of a common material on a single substrate, such that fluctuations in the variable reference voltage over process, supply voltage and temperature variations operate to reduce fluctuations in a ratio of (1) current produced by the current source and (2) the operating current of the core circuit.

3. The circuit of claim 2, wherein the operational circuitry comprises:
at least one transistor coupled to the bias resistor, wherein the at least one transistor and the transistor of the reference circuit are one of n-channel field effect transistors and p-channel field effect transistors.

4. The circuit of claim 1, wherein the voltage regulator comprises a low dropout (LDO) regulator providing a voltage at the output that substantially tracks the variable reference voltage.

5. The circuit of claim 1, wherein the current source comprises a bandgap reference circuit.

6. The circuit of claim 1, wherein the core circuit comprises a voltage controlled oscillator.

7. The circuit of claim 1, wherein the core circuit comprises a phase locked loop (PLL) configured for use in a communication device.

8. The circuit of claim 1, wherein the core circuit comprises a differential current mode logic (CML) input to single complementary metal oxide semiconductor (CMOS) output transformation circuit.

9. An integrated voltage controlled oscillator (VCO) circuit, comprising:
a tank circuit;
a gain stage coupled to the tank circuit;
a bias resistor, a first side of the bias resistor coupled to either the tank circuit or the gain stage; and
a compensation circuit including:
a reference circuit including a current source, a reference resistor, and a transistor coupled in series between a supply voltage and ground to produce a variable reference voltage at a first side of the resistor; and
a voltage regulator having an input coupled to the first side of the reference resistor and an output coupled to a second side of the bias resistor.

10. The integrated VCO circuit of claim 9 further comprises:
the reference resistor and the bias resistor being formed of a common material on a single substrate.

11. The integrated VCO circuit of claim 10, wherein the gain stage comprises first and second cross-coupled transistors.

12. The integrated VCO circuit of claim 11, wherein the first and second cross-coupled transistors and the transistor of the compensation circuit comprise re-channel field effect transistors.

13. The integrated VCO circuit of claim 11, wherein the first and second cross-coupled transistors and the transistor of the compensation circuit comprise p-channel field effect transistors.

14. The integrated VCO circuit of claim 9, wherein the voltage regulator comprises a low dropout (LDO) regulator providing a voltage at the output that substantially tracks the variable reference voltage.

15. The integrated VCO circuit of claim 9, wherein the current source comprises a bandgap reference circuit.

16. The integrated VCO circuit of claim 9, wherein the bias resistor comprises a digital potentiometer.

17. A method for reducing supply current variations in a core circuit having a bias resistor, comprising:
providing a reference current;
utilizing the reference current to produce a reference voltage across a reference resistor and a transistor coupled in series with the reference resistor;
providing the reference voltage to an input of a voltage regulator; and
utilizing an output of the voltage regulator to establish an operating current through the bias resistor,
wherein the reference voltage is variable across process, supply voltage and/or temperature variations to reduce differences between the current density of the reference current and the current density of the operating current.

18. The method of claim 17, the reference resistor and the bias resistor manufactured of a common material on a single substrate.

19. The method of claim 17, wherein the regulator comprises a low dropout (LDO) regulator providing a voltage at the output that substantially tracks the variable reference voltage.

20. The method of claim 17, wherein the core circuit comprises a voltage controlled oscillator (VCO).
